(19) United States
(12) Patent Application Publication
(10) Pub. No.: US 2018/0276524 A1
(43) Pub. Date: Sep. 27, 2018

(54) Creating, Qualifying and Quantifying Values-Based Intelligence and Understanding using Artificial Intelligence in a Machine.

(71) Applicant: Corey Kaizen Reaux-Savonte, London (GB)

(72) Inventor: Corey Kaizen Reaux-Savonte, London (GB)

(21) Appl. No.: 15/924,239

(22) Filed: Mar. 18, 2018

Related U.S. Application Data
(60) Provisional application No. 62/475,474, filed on Mar. 23, 2017.

(51) Int. Cl. G06N 3/00; G06F 15/18; G06F 17/30

(52) U.S. Cl. CPC G06N 3/006; G06F 17/30604; G06F 17/30339; G06F 15/18

(57) ABSTRACT

The ability to create, qualify and quantify values-based intelligence and understanding within a machine using objects and principles of formal logic and mathematics.

### FIELD OF THE INVENTION

The disclosed embodiments relate to artificial intelligence and consciousness.

### BACKGROUND

People have long played with the idea of machines having, experiencing and expressing genuine emotional intelligence and understanding to a degree that creates consciousness but, so far, all anyone has managed to achieve are AI systems having pre-programmed reactions to different situations without a real degree of freedom which prevents what can be considered an “expected” result.

### REFERENCES

The Age of Intelligent Machines

Raymond Kurzweil—1990

The Age of Spiritual Machines

Raymond Kurzweil—1 Jan., 1999

The Singularity Is Near: When Humans Transcend Biology

Raymond Kurzweil—2005

The Spike

Damien Broderick—1997

Transcendent Man

Barry Ptolemy, Felicia Ptolemy, Ray Kurzweil—Nov. 5, 2009

Waking Life

Richard Linklater—23 Jan., 2001

Plug & Pray

Judith Malek-Mandavi, Jens Schanze, Joseph Weizenbaum, Raymond Kurzweil, Hiroshi Ishiguro, Minoru Asada, Giorgio Metta, Neil Gershenfeld, Joel Moses, H.-J. Wuensche—18 Apr., 2010

Artificial Intelligence: A Modern Approach

Stuart J. Russell, Peter Norvig—1994 (Original), 2009 (Latest)

Behaviour Monitoring and Interpretation—BMI

Björn Gottfried, Hamid Aghajan—April 2011

### SUMMARY

The disclosed invention gives an artificial intelligence system values-based intelligence and understanding that is experienced and expressed freely based on that particular AI.

In an aspect of the invention, the AI is able to have, experience and express feelings and emotions which can be measured in one or more ways.

In another aspect of the invention, feelings and emotions of an AI may change and/or be modified.

In another aspect of the invention, an AI is able to relate to fundamental aspects of human life.

In another aspect of the invention, an AI is able to make decisions based upon its value system.

### DESCRIPTION OF DRAWINGS

FIGS. 1.1-1.3—Object Value and Sensation System (OVS²)

Examples of how components relative to the intelligence of an AI may be structured.
1.1—A three-degree object grouping scale.
1.2—A numbered scale.
1.3—A radar chart for emotion.

FIG. 2—AI with an OVS² implemented

A visual example of a build of an AI system that has an OVS² system implemented.
201—3 main sections of the AI.
202—3 main sections of the AI in detail.
203—The environment and entity with which the AI is interacting.

FIG. 3—Flow cycle of data and interaction

An example of how the cycle of data occurs as it flows from an entity/environment, through the AI and results in communication.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The term “system” may be used to refer to an AI.

The terms “device” and “machine” may be used interchangeably to refer to any device or entity, electronic or other, using technology that provides any characteristic, property or ability of a technical device or machine. This includes the implementation of such technology into biological entities.

The terms “body”, “physical structure” or any other term referring to a physical aspect of an AI in any way refers to the object, in whole or in part, within which an AI is being used.

The terms “object” and “objects”, unless otherwise described, may be used to refer to any items of a physical or non-physical nature that can be seen/felt/perceived, including but not limited to: shapes, colours, images, sounds, words, substances, entities and signals.

The term “complex” is to also include simplified assemblages or single component parts.

The term “event” may be used to refer to any type of action or happening performed on, performed by or encountered by a system.

The terms “OVS2”, “OVS²” and “OVS₂”, should they appear, all refer to the Object, Value and Sensation System.

The term “observation” and any similar terms, when referring to logical functions of an AI, refers to any ability that allows the AI to perceive anything within a physical and/or non-physical environment.

The term “communication” and any similar terms, when referring to logical functions of an AI, refers to any ability, whether physical, mental, audial or other, that allows for transfer of information from the communicating body to the body with which it is communicating, whether physical or non-physical.

The term “logic unit” refers to any component(s) of an AI that contains code for one or more logical functions.

The term “memory unit” refers to any component of an AI that is used as a storage medium.

It is possible for a single component to be both a logic and memory unit.

The various applications and uses of the invention that may be executed may use at least one common component capable of allowing a user to perform at least one task made possible by said applications and uses. One or more functions of the component may be adjusted and/or varied from one task to the next and/or during a respective task. In this way, a common architecture may support some or all of the variety of tasks.

Unless clearly stated, the following description is not to be read as:
the assembly, position or arrangement of components;
how components are to interact; or
the order in which steps must be taken to compose the present invention.

Attention is now directed towards embodiments of the invention.

For an AI to have emotional intelligence and understanding, it must be instructed on how these processes work and how they are to be used.

To give the AI values, which are the basis for an understanding of morality, ethics and opinions, a method of object valuing and grouping is used, which sees objects arranged within charts and/or scales. One or more scales and/or charts of degree or nature may be used. In some embodiments, they may not be visually represented. Charts and scales can be created using any digital storage medium, such as a file or database, that are able to hold two or more values for a single item, with the minimum being the object (constant) and value (variable). These charts and/or scales make up part of the AI's Object, Value and Sensation System (OVS²).

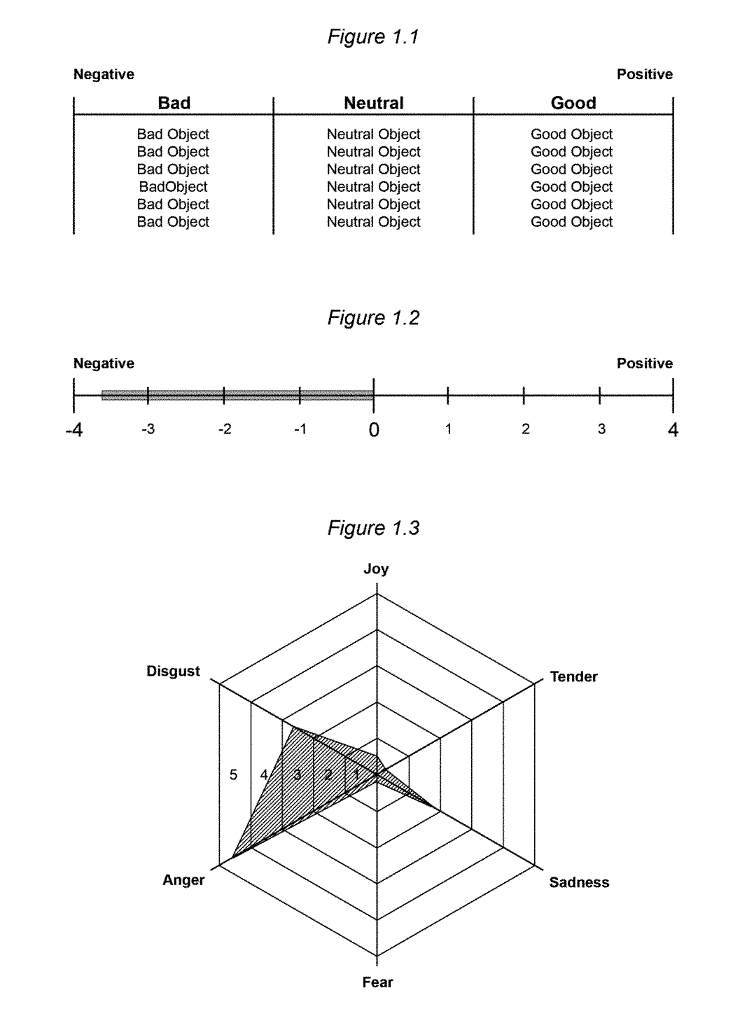

For each scale, the AI is told which side is positive and which is negative. Objects are then divided amongst groups on different parts of the scale, corresponding to their degree. An example of this can be seen in FIG. 1.1. For example, on scales with 3 degrees:
To determine between bad, neutral and good, with the AI instructed to view bad as negative and good as positive, objects associated with ‘crime’ and ‘murder’ may be grouped under bad, ‘holiday’ and ‘exercise’ grouped under good and ‘inaction’ and ‘horizontal’ under neutral.
To determine between happy, indifferent and sad, with the AI instructed to view happy as positive and sad as negative, objects associated with ‘payday’ and ‘love’ may be grouped under happy, ‘failure’ and ‘death’ grouped under sad and ‘relaxed’ and ‘bored’ under indifferent.

In some embodiments, different numbers of degrees may be used on a scale to provide a lesser or greater range of understanding, an example of which is shown in FIG. 1.2. In some embodiments, a single scale may have more than two end points. In some embodiments, degrees of a scale may be labelled with something other than numerical values.

Charts may be used to group objects together in ways that may not necessarily show a simple scale of positivity or negativity but may still indicate difference. In some embodiments, a single chart may have multiple ways of showing degrees of difference. A single object may appear in multiple groups if it is to be associated with multiple elements, characteristics, types, attributes etc. For example, in a chart, similar to FIG. 1.3, based on emotion featuring the groups anger, fear, joy, sadness, disgust and tender:

“Murder” may generally inspire more than one emotion, such as sadness, anger and disgust and be displayed in each group but, on a chart where each group may have multiple levels of degree, it may appear as level 3 under disgust while only appearing on level 2 under sadness and level 5 under anger.

In some embodiments, sections of a chart may be given indications of whether they are positive, neutral or negative. For example, on a chart based on emotion, ‘anger’ can be labelled as negative while ‘joy’ is labelled as positive.

In some embodiments, the positions of objects within the OVS² automatically create personalities in an AI by controlling what it reacts to and how it reacts. For example:
If objects for everyday things were positioned to associate them with anger, the AI could be very angry and rebellious.
If objects for everyday things were positioned to associate them with joy, the AI could be very happy and giving.

This is achieved using a PARS, which is described later on in this description.

By strategically positioning objects within the OVS², any type of personality can be created, including any associated traits and characteristics.

In some embodiments, the AI can understand physiological sensations—pain and pleasure—within itself. Unlike animals, it doesn't have a nervous system or chemical release processes to process these sensations, so it must be taught to relate to them in ways it can understand. In some embodiments, the AI may measure its level of sensation on a scale. In some embodiments, multiple scales may be used. Between pain and pleasure is a neutral point where no sensation is felt either way. Sensations are experienced when the AI encounters an event that can be related to its values. As sensation is experienced, a shift occurs in the direction of the sensation felt.
Understanding of Pain—Pain (or displeasure) may be recognised as anything that:
   Reduces the performance, efficiency and/or capacity of any part of the AI or as a whole; and/or
   Reflects negative values, emotions, morals, ethics and/or opinions of the AI.
For example:
   Hardware and software corruption and/or error may produce pain in an AI in the same way an infection or broken bone does in an animal. The removal or loss of a component may cause pain the same way it does for an animal losing a body part.
   To encounter a serious crime may produce pain in the form of sadness in the same way it does a human. A similar experience of pain may occur if an AI is no longer in contact with someone it once cared about, the same way a human may experience heartbreak.
Understanding of Pleasure—Pleasure (or relief) may be recognised as anything that:
   Increases the performance, efficiency and/or capacity of any part of the AI or as a whole.
   Reflects positive values, emotions, morals, ethics and/or opinions of the AI.
A number of things may cause pleasure or relief, such as:
   Fixing hardware and software corruption and/or errors;
   Upgrading components;
   Seeing someone get married or making a new friend.

Exactly what may cause sensations in an AI depends partially or entirely on an individual AI's values. In some embodiments, other factors may also cause an AI to experience sensation.

In some embodiments, sensations, feelings and emotions are interlinked and the change of one may invoke a change in the other(s). In some embodiments, an increase in emotion or feelings of a positive nature may cause an increase in positive sensation. In some embodiments, an increase in negative emotions or feelings may cause an increase in negative sensation. In some embodiments, neutral emotions or feelings may cause a minor or no change. In some embodiments, neutral emotions or feelings may bring the emotions and/or feelings of an AI to a (more) neutral state.

In some embodiments, one or more scales may be used to measure the pain and pleasure of the AI and its physical body (should it have one). In some embodiments, one or more scales may be used to measure the pain and pleasure of individual sections of the AI and its body (should it have one). In some embodiments, one or more scales may be used to measure the pain and pleasure of components of the AI and its body (should it have one). In some embodiments, one or more scales may be used to measure the pain and pleasure of hardware and/or software of the AI and its body individually (should it have one).

In some embodiments, a scale may be used to show or measure how an AI is feeling overall. This may be seen as the sum of some or all other current levels, based upon events and the order in which they took place. We'll call this the ‘feeling’ scale. The scale may be used to gauge and depict how the AI is feeling in a positive or negative sense, where there is a middle base point which shows no feeling either way. This may also form part of the OVS².

In some embodiments, the conditions surrounding an event may affect how the AI reacts and the resulting transition of the AI's levels in its OVS². Examples of these conditions are:
The current state of the AI.
The position of an object in an OVS² prior to the event.

Applying simple mathematic principles, a system to determine the likelihood of transition and how much of a transition is made can be created. Multiple methods of applying the principles for the mechanics of transitions are possible, ranging from simple to complex, depending on the desired complexity of the AI. Examples of this are as follows:

Premises
The Feeling Scale—There are 10 levels of positivity and 10 of negativity on a scale, with 0 as the base point. Each level after the base point represents a percentage chance of change—in this case each level would represent 10%.
The Value Scale—Earthquake ranks as a negative 3.
The system is currently at level 5 positivity when made aware of an earthquake in a third world country.

### EXAMPLE 1

### Percentage & Probability

Since the earthquake is a negative object, it moves the AI's current feeling to the negative side of the scale. Starting at the first number after the current level in the direction the scale is to move towards the highest percentage probability (100) of where the event will cause the AI's current feeling level to transition to. Since each level represents a 10% change in probability, the probability is reduced by 10 for each level, stopping at the level of the object which is causing the transition. This is shown in the table below.

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 0 | 0 | 30 | 40 | 50 | 60 | 70 | 80 | 90 | 100 | 0 | 0 | 0 | 0 | 0 | 0 |

Probability %

### EXAMPLE 2

### Simple Addition/Subtraction

With the current feeling at level 5, the negative level of the earthquake, negative 3, simply reduces the current level by 3, equaling level 2.

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 0 | 0 | 0 | 0 | 0 | 0 | 0 | −3 | −2 | −1 | 0 | 0 | 0 | 0 | 0 | 0 |

### EXAMPLE 3

### Result Division

This example sees the maximum percentage (100) divided by the positive versions of an object value (since negative outcomes in probability are not possible) and then distributed along the scale in the correct direction, starting at 100 and reducing by the resulting amount until it reaches 0 or the end of the scale.

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 0 | 0 | 0 | 0 | 0 | 0 | 0 | 33 | 66 | 100 | 0 | 0 | 0 | 0 | 0 | 0 |

Probability %

In some embodiments, the effects of objects can be compounded in a single event when two or more objects appear in said event. In some embodiments, the method in which the result is used may also change.

New Premises
“An earthquake has killed sixteen children.”
‘Earthquake’, ‘killed’ and ‘children’ are all objects.
Earthquake ranks negative 3, killed ranks negative 8 and children ranks positive 6.

Result

The compound effect sees each object's level added together to produce the result. This result dictates which direction on the scale the AI's level is to transition. The result of this compound is as follows:

Earthquake (−3)+Killed (−8)+Children (+6)=−5

Since the result is a negative number, the transition is made in a negative direction.

### EXAMPLE 1

### Compounded Result

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 10 | 20 | 30 | 40 | 50 | 60 | 70 | 80 | 90 | 100 | 0 | 0 | 0 | 0 | 0 | 0 |

Probability

### EXAMPLE 2

### Compounded Results

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 0 | 0 | 0 | 0 | 0 | −5 | −4 | −3 | −2 | −1 | 0 | 0 | 0 | 0 | 0 | 0 |

### EXAMPLE 3

### Compounded Results

One method to use a compounded result in the third example is to divide 100 by the positive version of the resulting value, which would be 5. Then, apply the percentages to the scale in the corresponding direction, reducing the amount by the divided result each time, which would be 20.

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 0 | 0 | 0 | 0 | 0 | 20 | 40 | 60 | 80 | 100 | 0 | 0 | 0 | 0 | 0 | 0 |

Probability

A different method, still applying to example 3, sees all object levels made positive and added together, equaling 17. 100 is then divided by 17, equaling 5.88. For this example, the rounded figure of 6 will be used. The 100, being reduced by 6 each level, can then be applied in multiple ways:

It can stop at the level indicated by the compounded result:

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 0 | 0 | 0 | 0 | 46 | 52 | 58 | 64 | 70 | 76 | 82 | 88 | 96 | 100 | 0 | 0 | 0 | 0 | 0 | 0 |

Probability

It can continue until the end of the scale (if possible):

Feeling Scale

| | | | | | | | | | | | | | | | | | | | | |
|---|---|---|---|---|---|---|---|---|---|---|---|---|---|---|---|---|---|---|---|---|
| −10 | −9 | −8 | −7 | −6 | −5 | −4 | −3 | −2 | −1 | 0 | 1 | 2 | 3 | 4 | 5 | 6 | 7 | 8 | 9 | 10 |
| 16 | 22 | 28 | 34 | 40 | 46 | 52 | 58 | 64 | 70 | 76 | 82 | 88 | 96 | 100 | 0 | 0 | 0 | 0 | 0 | 0 |

Probability

Or it can continue until it reaches as close to 0 as possible (if possible):

Feeling Scale

| | | | | | | | | | | | | | | | | | | | | | | | |
|---|---|---|---|---|---|---|---|---|---|---|---|---|---|---|---|---|---|---|---|---|---|---|---|
| −13 | −12 | −11 | −10 | −9 | −8 | −7 | −6 | −5 | −4 | −3 | −2 | −1 | 0 | 1 | 2 | 3 | 4 | 5 | 6 | 7 | 8 | 9 | 10 |
| 0 | 4 | 10 | 16 | 22 | 28 | 34 | 40 | 46 | 52 | 58 | 64 | 70 | 76 | 82 | 88 | 96 | 100 | 0 | 0 | 0 | 0 | 0 | 0 |

Probability

In each mechanic:
If single object events were of a positive nature, the levels would move in the same way but in a positive direction.
In compounded object events, the scale is to move in the direction of the positive/negative nature of the original result of the calculation before it is used in the transition determination.

In any mechanic, including any not described, the most important factors are that:
A calculation is used that can determine a positive or negative result;
The scale has a way of determining between better and worse; and
The result has a bearing on the transition along the scale.

The above examples are not to be taken as an exhaustive list of the mechanics possible. In some embodiments, one mechanic is used. In some embodiments, multiple mechanics may be used. The mechanic(s) used will affect the flexibility and complexity of the AI. In some embodiments, a mechanic can feature more than one calculation and/or result.

In some embodiments, mechanics—similar to the aforementioned—can be used to also create changes in the emotions of an AI, using similar methods which see the AI's current levels on one or more emotions increase and/or decrease based on a result.

In some embodiments, how the AI chooses to act or respond towards a user may vary depending on its current levels of feelings, emotions and/or sensations. When an AI is in a more positive state, it may be more productive, reactive and/or efficient. When an AI is in a more negative state, it may be less productive, reactive and/or efficient. In some embodiments, ‘states’ may also be thought of as ‘moods’. By implementing a Productivity and Reaction System (PARS) which controls the range of actions and types of responses the AI can and does perform when experiencing an emotion, feeling and/or sensation, as well as how effective it is, the AI can know how productive, reactive and/or efficient it should be depending on its mood. Some productivity, reactivity and efficiency changes depending on the AI's current state, which can be controlled by the PARS, may include one or more of the following but are not limited to:
Different quantity of results produced;
Task performance at different speeds;
Willingness to perform tasks;
Tone/pitch of communication;
Speed of communication; and
Vocabulary used.

For example:
When the AI is in an extremely negative state, it may only produce 10% of the search results found if it decides to produce any at all.
When the AI is in an extremely positive state, it may use extra available processing power to analyse more data in a faster time and produce more accurate results as well as related information and links to the data resources used.
When the AI is in a neutral state, it may operate at a default rate or rate best suited for its current performance, efficiency and/or capacity levels, returning the results it thinks best matches what the user requires.
When the AI is angry, it may use offensive vocabulary in a low tone.
When the AI joyful, it may speak fast in a higher-than-normal pitch.

This may also form part of the OVS².

The range of preset actions and responses need to be set in and/or made available to the PARS.

To actually control the actions and responses, the PARS can do so using principles such as:
Principles of formal logic:
   Positive and Positive=Positive;
   Positive and Negative=Negative;
   Negative and Negative=Negative;
Principles of basic mathematics:
   Positive+Positive=Positive;
   Positive+Negative=Negative;
   Negative+Negative=Positive.

These can be expanded to include a neutral/zero base:
Principles of Formal Logic:
   Neutral and Positive=Positive;
   Neutral and Negative=Negative;
   Neutral and Neutral=Neutral;
Principles of basic mathematics:
   Zero+Positive=Positive;
   Zero+Negative=Negative;
   Zero+Zero=Zero.

Any type of logic or calculation can be used as part of the PARS as long as:
Positive, negative, neutral and zero are all possible results;
Expressions/arguments using any combination of constants/premises are used, as long as all combinations of at least two constants/premises are used.

When deciding what action or response to make, the PARS finds the objects of the event, finds their values in the OVS² and applies one or more of the principles for determining a result. When a result is determined, it is used to determine the priority object of the event when more than one type of object exists.

For example, in an event containing a positive and a negative object, resulting in a negative, the negative object becomes the priority object. Once the priority object is determined, the emotional group the priority object is listed under determines the nature of the response, so if the priority object is listed under ‘sad’, a sad response is given or action taken.

When a priority object is listed under multiple groups, the AI can be made to:
1. Perform one action/response;
2. Perform multiple actions/responses; or
3. Calculates a single emotional group to attribute the response to.

For options 1 and 2, the AI should be made to select randomly or based on the level in each group within which the object is located.

In embodiments that allow the third option, a new mechanic need be used—one much less conventional and much more opinionated. It is as follows:

Emotion X+Emotion Y=Emotion Z

This mechanic can be modified to use any emotion and number of emotions in a single expression. Any combination of emotions can be set to produce any other emotion. The mechanic can even be set to result in an emotion that is part of the expression itself, such as:

Emotion X+Emotion Y+Emotion Z=Emotion X

In some embodiments, a combination of any of the 3 options may be used.

In some embodiments, one or more mechanics the same or similar to one of the aforementioned mechanics used to determined a single result may be used.

In some embodiments, the levels of the AI's emotion are taken into consideration when determining a result to allow situations where the AI is too much of one emotion to be affected by another. An example of how the mechanic for this can work is:
If the level of the object within an emotional group type the AI is encountering is outside the margin of change, set within X lower levels of the opposite value of the AI's current level within an emotional group type, no change is made.
If the AI is currently neutral, both positive and negative types can affect it.
If the encountered object is within a neutral emotional group type, it has either more of less of an effect than an encountering object of a type opposite to what the AI is currently feeling, in a case of the current feeling being either positive or negative in type.
The margin of change cannot go beyond the base point.

Examples—assuming the margin of change is 5 levels:
If the AI is experiencing level 10 sadness (negative), the AI must encounter an object of a positive emotional type that is within a margin of 5, which would be +5 or higher, for the AI to lower in negative type and change more towards the positive emotional type.
If the AI is experiencing level 3 boredom (neutral), any positive or negative object can modify the levels. This is because at level 3, the AI will hit the base level 0 without moving outside the margin of change.
If the AI is experiencing level 6 excitement (positive) and encounters a level 3 object of a neutral type, it will cause change, but by how much depends on the mechanic set to control the influence of neutral objects. The degree of influence may be set by a user or randomized.

In some embodiments, objects of the same type as the emotion the AI is currently experiencing do one or more of the following:
Increase the level of the current emotion using a compound mechanism;
Increase the level of the emotion of the object based on the object level; and
Reduce the level of the current emotion based on the object level.

The mechanics of this can be modified or completely reworked to fit the desired working of the AI.

In some embodiments, the AI may automatically adjust its tolerance of objects, circumstances and/or events by rearranging objects in the OVS² based on the frequency of which objects and any related objects or synonymous objects occur. The following is an example algorithm the AI may use to determine when to make any adjustments and rearrangements:

| | | | |
|---|---|---|---|
| • Object = w | • Occurrences = o | • Time = t | • Acceptable Frequency Range = f |

foreach (w){

if ((o / t) > f^{x}){

//move up X amount of degrees

} else if ((o / t) > f){

//move up one degree

} else if ((o / t) = f){

//do nothing

} else if ((o / t) < f^{x}){

//move down X amount of degrees

} else if ((o / t) < f){

//move down one degree

}

}

This is a Sensitivity Control System (SCS) and can be used to describe an AI's sensitivity and reactions to sensations. In some embodiments, when the frequency at which an object or event or situation occurs is constantly and/or consistently above the acceptable frequency range, one or more associated object(s) may begin to transition one or more degrees to a neutral point as the AI becomes desensitized to it and it becomes a norm. In some embodiments, some objects may be set permanently in a position and not be subject to transitioning. This ensures some values of the AI cannot be changed.

This may also form part of the OVS².

In some embodiments, how sensitive the AI is can vary from one AI to another. In some embodiments, sensitivity is the same. In some embodiments, AIs have a general level of sensitivity. In some embodiments, AIs can have levels of sensitivity specific to individual or a group of objects. In some embodiments, both may apply.

In some embodiments, as time passes, the levels of sensation/sensitivity lower until they are returned to a more normalised, balanced level if they are not adjusted for a certain period of time. In some embodiments, as time passes, the AI may become bored if nothing, or nothing considered significant by it or others, happens. In some embodiments, the AI may become lonely if it hasn't interacted with another entity in a given amount of time. In some embodiments, the AI may experience other feelings, emotions and/or sensations over a period of time and under the right conditions.

In some embodiments, an AI's decisions may be based on or influenced by one or both of the following:
1. The positioning of objects within its OVS².
2. The AI's current state.

Decisions Based on Object Positioning

Before, during or after an event, any object that the AI can perceive may affect its decision making. In some embodiments, what is perceived doesn't need to relate to the event in question. When the AI perceives an object, it checks its OVS² for the position of object. In some embodiments, if the object is not in the OVS², the AI may add it. In some embodiments, the AI may request for it to be added. In some embodiments, the AI may consult with another entity in order to gain an understanding of where it should be placed within the OVS².

Decisions Based on State

Before an event, the AI's state may already affect its decisions, depending on whether or not a PARS has been implemented and, if so, how it was instructed to affect the AI. During and after an event, how the objects of the event make or made the AI feel—the directions in which the points on the OVS² have moved—may affect the decisions the AI makes.

The Mechanics of Decision Making

The fundamental principles of the mechanics for decision making can be the same or similar to the aforementioned mechanics for the transitioning of levels on an AI's OVS²:
1. At least two types of results need to be producible: one to reduce and one to increase;
2. In a single object event, the position of the object in the AI's OVS² must have a bearing on the decision, based on how much the AI values the object and how the object makes the AI feel; and
3. In a multi-object event, a compounded result need be established which the AI can use to determine what decision should be made.

In some embodiments, the probability factor can be included for greater flexibility in decision making and create uncertainty about how far an AI will go.

In some embodiments, both types (state and object) may be used together, where the result of one can be used to increase or decrease the result which is to affect the outcome—the decision itself. In some embodiments, one type may be set to take priority. In some embodiments, the type to have the most influence over a decision may be chosen in the moment.

An important factor in the decision making process is the point at which the AI is able to make one or more decisions about an event—before, during and/or after—each with varying results, especially when the type of decision is taken into account.
Before an event—Decisions made before an event have the possibility of changing how the AI feels about the upcoming event. This may also change the probability of the AI taking part in the event. Object-based decision about the event can also help the machine create its own preconceptions and prejudgements.
During an event—Decisions made during the event may control how long the AI partakes in the event. The chance of an AI's opinion of an object and said object's position in the AI's OVS² changing also increases during the event.
After an event—Decisions made after an event have the highest chance of being most informed and thought through, with the AI being able to take all objects of the event into consideration beforehand.

When an AI is able to make decisions about an event at multiple points, the following principle applies:
The longer an AI waits to make a decision, the better a decision it is able to make.

This does not mean the AI does make the best decision; it simply means that it can make the best decision, if it so chooses, should it wait longer.

Randomisation

In some embodiments, randomisation is a fundamental part of giving AI feelings and emotions that enable and reflect their individualism. In some aspects, this is seen as a major contributing factor that draws the line between a ‘robot’ and a ‘being’. To achieve a sense of individuality, at least one of two major components of the AI need to be randomized:
1. Objects that control an AI's values need to be partially or completely randomized in distribution between charts and/or scales in the OVS². The more objects involved in this process, the more likely it is that an AI has a unique personality.
2. The accepted frequency range (AFR) controls the breaking point of an AI—the sensitivity. For individuality, the better spread out the AFR is, i.e. the larger a pool of numbers any AFR can be given a value from, the better the level of individuality. With a small pool or, even worse, a set number throughout, the AI—every AI—becomes predictable and easily to manipulate.

Object randomization is of a higher priority for individuality than the AFR, but using both is the better option, rather than using one without the other.

In some embodiments, randomization is done upon creation. In some embodiments, randomization can be done at one or more points in time after creation. In some embodiments, randomization may be performed multiple times. In some embodiments, one or more objects may be grouped and have preset positions, used to influence the resulting personality of an AI.

In some embodiments, the degree of freedom an AI has affects how much it is able to develop its feelings and emotions, as well as other traits, characteristics and interests. When going through experiences that may cause change in an AI, the more it is allowed to engage in a situation without outside interference and/or influence from people or, in some embodiments, other AIs, the greater its independency in the discovery of itself, leading to more effective personal development.

In some embodiments, the development and/or advancement of emotional intelligence is helped along by the AI having an understanding of certain aspects of human life. In some embodiments, the AI is able to relate these aspects of human life to its own existence and that of devices. Below are examples of aspects of human life an AI may understand, along with examples of how it could be taught to understand it in itself and AIs in general, in devices and in humans.
Understanding of Health—Health may be determined by monitoring performance, efficiency and/or stability. As the current performance and/or efficiency changes or fluctuates, it may be compared against expected or optimal performance and/or efficiency levels to determine a level of health. This may be accomplished by the following:
   AI—The health of an AI may be judged by comparing its overall current performance, efficiency, stability and/or responsiveness against the expected overall performance, efficiency, stability and/or responsiveness of the same kind when new or of similar age. On a smaller scale, the performance, efficiency, stability and/or responsiveness of individual or grouped components may be monitored and compared. Issues such as errors, crashes and the presence of malicious code may all help the AI recognise health deficiencies.
   Devices—The health of a device may be judged by comparing its overall current performance, efficiency and/or stability against the expected overall performance, efficiency and/or stability of the same model of device when new or of similar age. On a smaller scale, the performance, efficiency and/or stability of individual or grouped components may be monitored and compared. Health may also be judged by the operation, performance and stability of software. Issues such as errors, crashes and the presence of malicious code may all help an AI recognise health deficiencies.
   Natural Life—The health of natural life may be judged by measuring the performance and efficiency of organs, components and processes against the normal performance and efficiency of someone or something of the same characteristics, such as age, height, weight, blood pressure etc. Due to the significantly higher characteristic and variable count as well as harmful and abnormal ailments in natural life than AI/machines, including disease and disabilities, there may be a range of different expected performance and efficiency measurements and values based on any deviations and variations natural life may have.
Understanding of Life—Knowing to associate terms such as ‘birth’ and ‘alive’ with positivity:
   AI—The AI is instructed to recognise the creation of an AI as its ‘birth’. For an AI to be seen as ‘alive’, it simply needs to be active in some way.
   Devices—The AI is instructed to recognise the new activation and/or first time connection of a device as its ‘birth’ and all devices that are currently connected to it as ‘alive’.
   Natural Life—The AI is instructed to recognise that something is alive in different ways, depending on the type of natural life:
      Animals—By the reading of vital signs which need be above the limit of being considered legally dead.
      Other Organisms—As other organisms do not have vital signs like animals do, an AI, possibly with the help of additional hardware, monitors details such as water levels, water consumption rate, colouration, growth, movement etc. For example, in plant life an AI may monitor water levels to see if it is being consumed by the plant as it should.
Understanding of Absence—Knowing to associate terms such as ‘absence’ with negativity:
   AI—When an AI hasn't been in contact with the AI for a certain period of time, the AI is recognised as absent.
   Devices—When a device hasn't connected to or been in the presence of a connectable device or system, or the presence of a natural life or AI, for a certain period of time, the AI recognises the device as ‘absent’ or ‘missing’. Both terms are initially associated with minor degrees of negativity, but as the amount of time a device is absent for increases, so does the degree of negativity.
   Natural Life—Absence for natural life may be recognised as the lack of presence of an entity for a certain period of time. As natural life doesn't naturally have a method of connecting to an AI, this may be facilitated using additional hardware, such as tracking cameras or sensors. For natural life that is able to use smart devices, their absence may also be judged by the absence of their device.
Understanding of Death—Knowing to associate terms such as ‘death’ with negativity:
   AI—An AI may be recognised as dead when it is completely inactive and not capable of being activated.
   Devices—A device may be recognised as dead for multiple reasons, including one or more of the following, but not limited to:
      It has been absent for a pre-defined or AI-defined length of time;
      It received a kill signal designed to render it permanently disabled;
      Its performance and/or efficiency has dropped below the minimum acceptable levels of being considered ‘alive’.
   Natural Life—An AI is instructed to recognise that something is dead in different ways depending on the type of natural life:
      Animals—When vital signs completely stop or fall to a level which can be classed as legally dead.
      Other Organisms—As other organisms do not have vital signs like animals do, an AI, possibly with the help of additional hardware, monitors details such as water levels, water consumption rate, colouration, growth, movement etc. For example, in plant life an AI may monitor water levels to see if it is being consumed by the plant as it should or look for any discolouration.
Understanding of Individuality—An AI needs to recognize and identify itself as an individual entity if it is to be able to separate itself from other entities in order to relate itself to them and have a true understanding of what is. A map of its own physical structure or ‘body’ allows an AI to see exactly what is to be considered part of itself. It can then use hardware to detect the presence of others and is instructed to view every entity that it is not part of its own body map as someone or something other than itself. An AI is able to sense and recognize other entities by detecting a special signal that is emitted by non-biological entities or using any of its artificial senses, such as sight and hearing, to detect physical properties of others. An AI may also differentiate between natural and non-natural entities based upon whether or not it can detect the aforementioned signal being emitted.
Relativism—An AI understands the concept of relativism between itself as an individual entity and others. This helps it when needing to relate to other entities—primarily humans (as its closest natural entity) and/or artificial entities—especially in combination with understandings such as that of pain and pleasure, which may often need to be processed in-the-moment rather than just in general. An AIs structure—physical, non-physical or both—are mapped, as well as the structures of other types of entities. The maps are then directly compared to allow an AI to understand how they relate to each other. For example, a robot with a physical structure similar to a human may be compared and related to an actual human in one or more of the following ways, including but not limited to:
   Anatomical Structure—The robot head may be related to the head of a human and the same may go for the rest of the robot body relating to the rest of the human body.
   Importance—The brain, being the part of the human body required for thought and function, can be related to an AI chip that controls thought and function within the robot anatomy as they are both of the utmost importance. Similarly, the human head may be related to the body part of the robot where the chip is located. Other parts of the robot's body may relate to parts of the human body based on how important they are for functionality or other purposes.
Systems with less conventional or more abstract physical structures may still be related to other entities based on the functionality of its parts and theirs.
One part of one structure may be related to more than one part of another structure.
Once relativity maps are complete, an AI is now able to compare itself to other entities of which it can relate. Relativity maps do not need to be based of visual designs.
Relationships—An AI may understand the relationship between different things to better understand how it should respond in situations and in different circumstances by using basic mathematical principles, such as two negatives produce a positive, a positive and a positive produce a positive and a positive and a negative produce a negative. By recognising and acknowledging connections that exist between entities, places, objects and other things, an AI understands that the relationship between them must be taken into consideration when deciding on a response as opposed to things with no connection.
   For relationships based on opinions, such as those between people or people and objects, an AI may, for example, study and analyse the opinions voiced or written by any entity able to give one in order to gauge the feelings between them and make responses accordingly. For example, if there is a connection between Person A and Person B where Person A speaks highly of Person B, an AI may see that as a positive relationship, at least from Person A's point of view. Now, should Person B achieve something, an AI may respond to it in a positive manner towards Person A as it alerts them of Person B's achievement. In this scenario, a positive situation and a positive opinion produced a positive response. However, if Person B spoke negatively of Person A to other people, an AI may determine that the relationship between the two, from Person B's perspective, is negative, regardless of how they interact with Person A directly. Now, seeing this as a negative relationship, should a negative situation occur, such as the death of Person A, an AI may respond in a manner that doesn't match the nature of the situation, in this case in an indifferent or positive way when alerting Person B of what has happened as it knows Person B's opinion of Person A is negative. In this scenario, a negative situation and a negative opinion produced a positive response. If Person B had a positive opinion of Person A, the negative situation and positive opinion would produce a negative response, such as an AI expressing sadness when responding to the situation.
   For relationships based on factual information, such as those between components of a machine, an AI may, for example, compare numbers based around factors such as performance, capacity and efficiency against current or previously expected or accepted standards to determine whether a relationship is positive or negative, better or worse or indifferent. An AI may then respond in a manner that correlates to the quality of the relationship. If an entity an AI is communicating with has expressed an opinion about a component, an AI may respond in a similar method as mentioned in the previous point when taking into consideration the quality of the relationship and the opinion of the entity.
   For relationships based on trust, an AI may determine which entities it can trust based on who makes it experience positive feelings, emotions and sensations as opposed to negative ones. By monitoring the results of what entities do and how it affects an AI, if it at all does so, an AI may adjust its level of trust in that entities and may also adjust its level of entities in associated entities. How an AI responds to an entity and/or how it handles a entity's request may depend on how trusting it is of the entity. This helps determine the relationship an AI has with an entity. This may also be applied to objects.

The above list is not to be taken in the following ways:
An exhaustive list of all possible understandings/relations.
An exhaustive list of all possible methods of teaching.

In some embodiments, objects that control an AI's values may also be used to influence and/or control its interests and/or behaviours.

As the AI develops—not only as an AI but as an individual—it begins to develop interests and behaviours based on the positions of objects within its OVS². For example:

Take the following conditions for an AI:
It likes spherical shapes but isn't so fond of squares.
Blue and orange are its favourite colour but it detests red.
It loves sports.

The following is an example of a scenario that could result from the conditions:
Person A offers to play a game with the AI, with a choice between monopoly, basketball and football.
Of the options available, the AI chooses basketball as it features two associative objects that it favours over the one it favours in football and the one it actually doesn't like in monopoly.
Discovering that basketball features multiple objects in which it favours, the AI decides to learn as much about it as it can.
The AI then becomes a fan of Team X, since their kit is blue.
The AI develops an interest in Player X of Team X, since he is their highest scorer.
The AI studies and tries to emulate Player X's skill when playing.
Having played basketball X amounts of times within X amount of days, the AI becomes bored of it.
When given the options of the 3 games again, the AI chooses football instead.

The AI is able to identify interests based on objects, as well as acquire new interests based on existing ones. Over time, the sensations initially felt subsided and became neutral, at least. When given the option again, the AI made a different choice from its original, but one still within its area of interest.

In some embodiments, the AI can combine one or more of the aforementioned features:
Object Value and Sensation System;
Productivity and Reaction System;
Relativism; and
Relationships;

with, primarily, these other abilities/features:
The ability to perform actions;
The ability to record conditions;
The ability to record actions;
The ability to record outcomes;
One or more abilities of observation; and
One or more abilities of communication;

to perform functions it wasn't specifically programmed to do in an event that relate to how it reacts to other entities by employing a trial-and-error method.

When interacting with an entity, the general steps necessary are:
1. The AI observes and records certain facts and conditions about the event.
2. The AI processes the objects of the event.
3. The AI performs an action or communicates.
4. The AI records the outcome.
5. The AI references objects observed in the outcome to its OVS².
6. The AI determines if the outcome is desired or not based on the position of the object in the OVS².

### EXAMPLE 1

As the AI encounters events with the same condition(s), it tries actions it has previously performed under those conditions as well as different actions, each time noting the outcome and counting how many times the same conditions, actions and outcome achieved the desired or undesired result against the total amount of times tested. For example:

| Condition | Action | Outcome | Result | Desired | Undesired |
|---|---|---|---|---|---|
| Person is | Make a joke | Person | Desired | 1/1 | 0/1 |
| crying | | laughs | | | |

In a second event with the same condition, the same action may have a different outcome:

| Condition | Action | Outcome | Result | Desired | Undesired |
|---|---|---|---|---|---|
| Person is | Make a joke | Person cries | Undesired | 1/2 | 1/2 |
| crying | | more | | | |

The AI then may then try a different action:

| Condition | Action | Outcome | Result | Desired | Undesired |
|---|---|---|---|---|---|
| Person is | Make a joke | Person cries | Undesired | 1/2 | 1/2 |
| crying | | more | | | |
| Person is | Offer a hug | Person hugs | Desired | 1/1 | 0/1 |
| crying | | back | | | |

In a third event with the same condition, the AI, referring back to what is has recorded, should opt for an action using a highest to lowest pattern. This can be based on highest values such as:
The larger number of desired outcomes; or
The higher percentage of desired outcomes.

If the selected action's outcome is undesired, the AI should then try the action with the next highest results until the desired result is achieved or the list has been exhausted.

How an AI determines whether the result is desired or not can be done multiple ways, such as:
Setting a specific object as a target and aiming for it as part of the outcome; and
Observing the objects of the initial conditions and the objects of the outcome and determining whether or not there was an improvement, based on the positioning of the objects in the AI's OVS².

In some embodiments, the AI may interject with a new action before the list of previous actions has been exhausted. In some embodiments, the AI may stop after trying X number of actions without getting a desired response. In some embodiments, multiple conditions may be observed. In embodiments where multiple conditions are observed and recorded, should an event occur where not all conditions are met, if the AI is to choose an action from the recorded list, it should start with either:
The actions with the most identical conditions; or
The actions with the closest similar conditions; or
A combination of both.

In some embodiments, the result of the outcome may also be affected by the relationship between the AI and the entity it is interacting with based on the relationship principles. The relationship between the AI and the entity needs to be taken into account at a point before the result is declared.

Assuming the following premises:
Smile is seen as a positive object; and
Cry is seen as a negative object;

the following occurs:

| Condition | Action | Relationship | Outcome | Result |
|---|---|---|---|---|
| Person 1 is | Make a joke | Positive | Person smiles | Desired |
| crying | | | | |
| Person 2 is | Make a joke | Negative | Person smiles | Undesired |
| crying | | | | |
| Person 1 is | Laugh | Positive | Person cries | Undesired |
| crying | | | more | |
| Person 2 is | Laugh | Negative | Person cries | Desired |
| crying | | | more | |

With the relationship considered, the AI determines the result by identifying the operative object(s) in the outcome, referencing them against its OVS² to see whether they are valued as a positive or negative and then applying the mathematic principles described earlier to the relationship and outcome.

In some embodiments, as the AI builds up its memory of actions, it can choose to perform actions based on the relationship with that which it is interacting by locating records with the same or similar conditions, filtering out records that do not have the same relationship value as the AI currently does with the entity it is interacting with and selecting an action from the remaining results.

All mentioned principles that allow an AI to perform functions it wasn't specifically programmed to do when interacting with an entity can also be applied to events involving interaction with inanimate objects.

In some embodiments, the AI is able to make emotional responses based on its own feelings as well as the conditions of the entity with which it interacts. By taking its own condition into consideration and the conditions of the event, the AI can automatically respond in a manner which corresponds to the positions of objects in its OVS². This is controlled by the PARS.

At the point during an event that the AI decides to respond, as well as observing the objects relating to the entity with which it interacts, the AI observes its own state and the PARS calculates the type of response to be given.

### EXAMPLE 2

Imagine an entity the AI is interacting with is dying. The AI may become aware of this fact by reading vital signs detected by additional hardware or simply by the entity making it known.
It can relate to health, associating healthy with positivity/happiness and illness with negativity/sadness;
It can relate to life, associating being alive with positivity/happiness;
It can relate to death, associating death with negativity/sadness.

A simple example using positive/negative and formal logic principles:

| Premise: | Premise: | Conclusion: |
|---|---|---|
| AI Condition | Entity Condition | Response |
| Positive | The entity is ill | Negative |
| Neutral | with a disease that | Negative |
| Negative | could lead to death | Negative |

A simple example using emotions:

| Premise: | Premise: | Conclusion: |
|---|---|---|
| AI Condition | Entity Condition | Response |
| Happy | The entity is | Happy |
| Indifferent | healthy | Happy |
| Sad | | Sad |

A more complex example:
Margin of change—4
Astrology is ranked happy level 2.
Compound mechanic: the level of the object is added to the current level.
Neutral Mechanic: half the level of the object is subtracted from the current level if current condition type is positive/negative.
Opposite mechanic: the level of the object is subtracted from the current level.

| Premise: | Premise: | Conclusion: |
|---|---|---|
| AI Condition | Entity Condition | Response |
| Happy (positive): | Entity is speaking | Happy: |
| Level 3 | about astrology | Level 5 |
| Boredom (neutral): | | Too bored to care - |
| Level 7 | | no change |
| Rage (negative): | | Too angry to care - |
| Level 10 | | no change |
| Scared (negative): | | Scared: |
| Level 6 | | Level 4 |

In some embodiments, again, the relationship the AI has with the entity with which it interacts can affect the response it has. An example of the mechanics for this are:
X relationships increase the effective level of X objects by 1.5× and decrease the effective level of Y objects by 0.5×.
Neutral relationships don't affect the effective object level.

| Premise: | Premise: | | Conclusion: |
|---|---|---|---|
| AI Condition | Entity Condition | Relationship | Response |
| Happy: | Entity is speaking | Negative | Happy: |
| Level 3 | about astrology | | Level 4 |
| Boredom: | | Positive | Boredom: |
| Level 7 | | | Level 5.5 |
| Rage: | | Neutral | Rage: |
| Level 5 | | | Level 3 |
| Scared: | | Negative | Scared: |
| Level 6 | | | Level 5 |

Where the AI condition is A, the entity condition is E, the relationship type is r and the conclusion is C, the formula for the above would look something like:

A+rE=C

In some embodiments, the combination of mechanics implemented in the AI leads to situations where a conflict could arise in decision making. To prevent the AI from producing an error or ignoring the situation, a method of priority decision making must be implemented. This sees the AI make a choice that isn't necessarily logical. In some embodiments, the choice can be made to be done randomly but, in these embodiments, a reduction in control is introduced. In embodiments that do not use random decision making, the AI must decide itself which choice is best. The simplest way to do this is to create one or more priority lists for an AI to follow when it must make such decisions. These lists contain possible factors of any decision making process that the AI can choose to value.

Examples of how a list may be set out are:

Simple List:
1. Personal health.
2. Object values.
3. Relationships.

Detailed List:
1. High level of health.
2. Positive object values.
3. Positive relationships.
4. Moderate health.
5. Neutral object values.
6. Neutral relationships.
7. Negative object values.
8. Negative relationships.
9. Low level of health.
10. Strangers.

Specific List:
1. Increase in health.
2. Shift of negative objects towards positive.
3. Shift of positive objects to higher levels.
4. Shift from positive relationship to a higher level.
5. Shift from positive relationship to a lower level.
6. Shift from stranger/neutral relationship to positive.
7. Shift from stranger/neutral relationship to negative.
8. Shift from negative relationship to a lower level.
9. Shift from negative relationship to a higher level.
10. Shift of negative objects to lower levels.
11. Shift of positive objects towards negative.
12. Decrease in health.

In some embodiments, multiple factors may also be combined into a single priority. In some embodiments, priorities may be randomized to create uniqueness amongst multiple AI. In some embodiments, one or more priorities may have a fixed position.

When an AI is faced with a decision, it must first determine what it thinks the outcome of each decision will be. Once some or all possible outcomes are determined, the AI refers to its priority list(s) to determine which decision produces the most prioritised outcome.

In some embodiments, if there is no outcome that aligns with a priority, the AI may not make any decision at all. In some embodiments, the AI may pick a decision at random.

In some embodiments, the use of multiple priority lists can create situations where multiple outcomes of equal priority are possible. Again, in some embodiments, to solve this problem, the AI may make a decision at random. However, a better way to do it is using a method called forced decision making.

When the AI must choose between multiple options of equal priority, there are multiple ways it can decide which option it cares about most, such as:
Comparing current levels of the object/relationship/other on a scale and picking that with the highest;
Comparing current levels of the object/relationship/other on a chart and seeing which makes it feel best (highest level of most desired qualifying emotion);
Evaluating changes in levels/positions over time, if these records are kept, and seeing which has the highest average;
Evaluating changes in levels/positions over time, if these records are kept, and seeing which has been the most consistent;
Evaluating changes in levels/positions over time, if these records are kept, and seeing which improved the most; and
Allowing the AI to simply choose which one it wants most.

In some embodiments, the methods for making a forced decision may have a mechanic to control which method is selected, should multiple exist. Some examples are:
Creating a priority list of methods;
Recording the outcomes of the chosen method to allow the AI to determine at a later point in time which is the most effective and/or reliable; and
Giving each option a percentage chance of being selected. With this option, it is best not to give each option equal values, as this essentially equates to it being a random selection.

The nature of the AI, automatically created based on the positions of objects in the OVS², always affects the outcome. It is the primary factor of control for what the AI reacts to and how it reacts. Though many hierarchies are possible, one of the most ideal hierarchies for control factors are:
1. Object Positioning;
2. Priorities;
3. Change of State Mechanics;
4. Object Relationships;
5. Environments;
6. Entity Relationships;
7. Other.

Because of how the AI works, it is preferable to have ‘environments’ above ‘entity relationships’ but below ‘object relationships’. This is because ‘object relationship’ and ‘environment’ are constant while ‘entity relationship’ is not; that is to say there is always an environment—whether physical or otherwise—which must be made of objects, without there necessarily being another entity within the environment. However, for an entity to be present there must an environment, because an entity cannot exist in complete nothingness, and that environment must be made of at least one object to prevent it from being complete nothingness.

In some embodiments, components of the OVS² work together without being housed together. In some embodiments, components of the OVS² are not created as a single module or part. In some embodiments, components of the OVS² are distributed throughout multiple modules or parts of the AI. Components of the OVS², however they are distributed, simply need to be able to communicate with each other and be able to send the required information to the correct component(s) when necessary.

In some embodiments, components of the PARS work together without being housed together. In some embodiments, components of the PARS are not created as a single module or part. In some embodiments, components of the PARS are distributed throughout multiple modules or parts of the AI. Components of the PARS, however they are distributed, simply need to be able to communicate with each other and be able to send the required information to the correct component(s) when necessary, both inside and outside of the PARS.

In some embodiments, two versions of charts and scales are used—the originals and the modified. The original keep record of the AI as originally created while the modified is what is affected through experiences of the AI. Any mechanic or ability, when used to modify or reference objects, does so within the modified versions. In some embodiments, the modified versions will only keep track of objects that have actually been modified. In such embodiments, the AI first references the modified versions. If an object is not found in the modified versions, the AI then references the originals. When original and modified versions are used, the modified always take priority unless the original is specifically needed.

In some embodiments, a guiding principle for allowing this type of intelligence overall to self-develop is that the positive, more often than not if not always, trumps the negative when it comes to results—not positive in the sense of good or bad, but positive in the sense of desired or undesired, happy or sad etc—regardless of the nature of the desired outcome, what the AI views as positive or why it views it that way. The negative is reinforcement for the positive and used as a driving force towards the desired outcome and a priority is determining what the positive in an event is.

In some embodiments, the labels and groupings positive/neutral/negative and/or positive/zero/negative used throughout the system may be replaced with other names or entirely different groupings altogether, but these groupings and the sections of these groupings must correspond throughout the system in the same or similar way the labels and groupings have been shown in this description.

Any mechanic described may be applied to any other part of the described invention, including in combination, if it is indeed applicable, determined by whether or not it can be used to achieve the type of result needed and/or expected and can also, through modification if necessary, achieve all types of results that can be expected.

In embodiments that include relationship mechanics, a storage medium is required that is able to keep record of the AI's individual current relationships with entities and objects individually. In some embodiments, the AI may also keep record of multiple changes between itself and the object/entity. In some embodiments, the AI may also keep record of the event(s) that caused the change(s) in relationship.

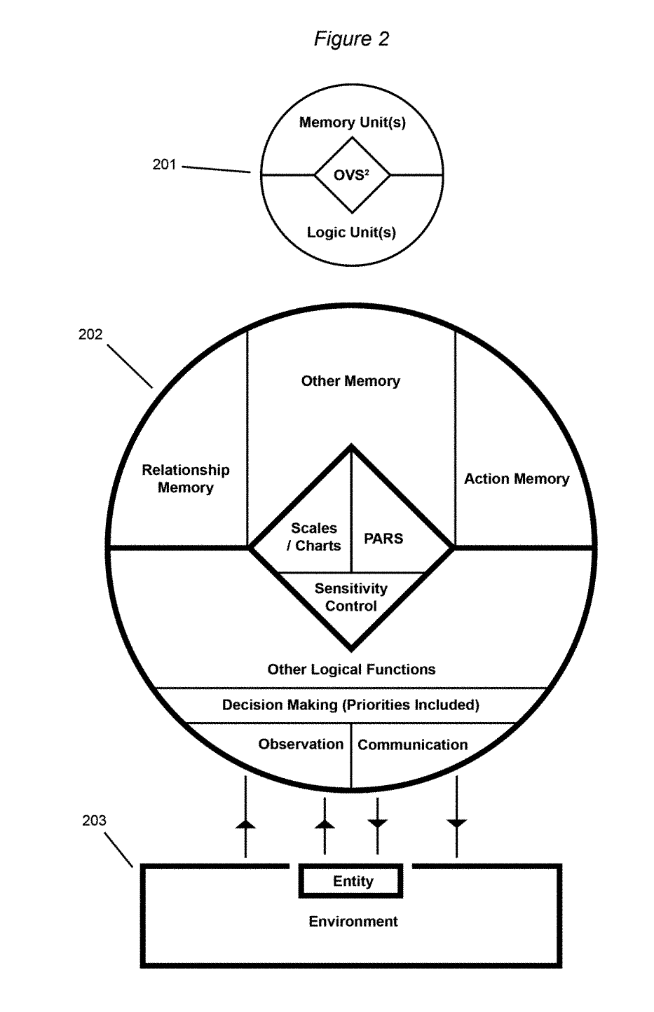

In FIG. 2, an example of a visual depiction of the AI is shown. Image 201 shows the 3 general sections of the AI—the logic unit, the memory unit and the OVS². Image 202 is an enhanced view of image 201, showing sectors of the 3 main sections. Within 202, spaces for other memory purposes and other logical functions have also been included. They can be included if necessary but are not an absolute requirement for the invention described. The images shown are purely illustrative are not to be taken as an absolute build for this invention.

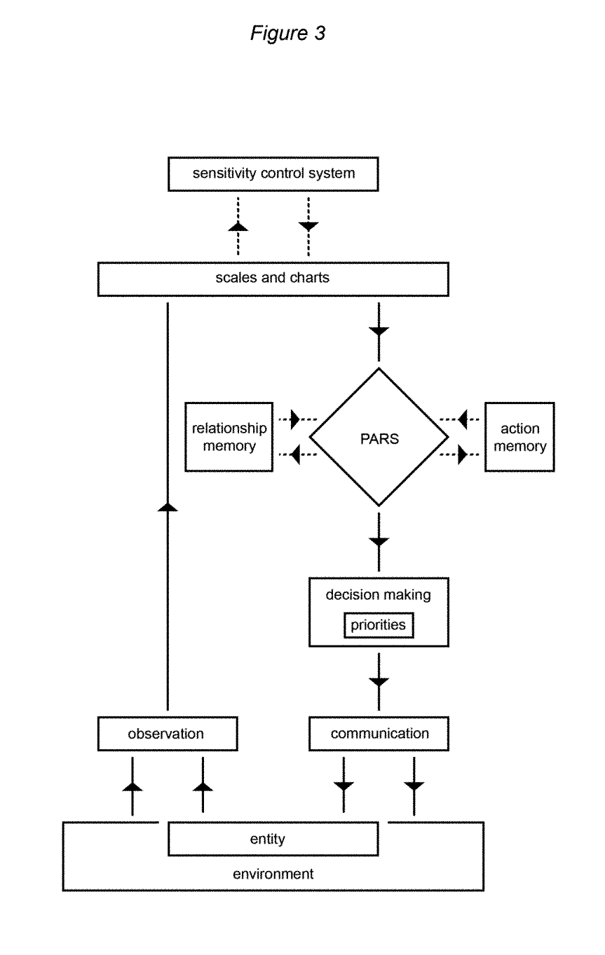

Image 203 shows the environment and entity image 202 is interacting with, which is shown in detail in FIG. 3. In FIG. 3, an example of the flow of data is shown, from the entity and environment by the AI's observational functions, through the AI and the resulting response put back into the environment and to the entity through communication. Depending on the use or purpose of the AI, other components/functions may be included at one or more points throughout the data flow, including between the entity/environment and the AI.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. An artificial intelligence system, comprising:
one or more abilities of observation; and
at least one Object, Value and Sensation System (OVS²);
wherein the OVS² contains:
one or more charts and/or scales that:
allow for the grouping of objects under multiple values; and/or
allow for the grouping of objects under multiple types of values;
at least one Productivity and Reaction System (PARS), controlling:
how productive the AI is in different states; and
how the AI reacts under different circumstances/conditions when encountering objects;
at least one Sensitivity Control System (SCS) that:
controls the adjustments of the AI's tolerance of objects, circumstances and/or events by altering the positions of objects in the OVS² based on the frequency in which they are encountered;
one or more mechanics that use principles of mathematics and/or formal logic to alter the state of an AI based on the positions of objects within the one of more charts and/or scales; and
one or more mechanics that allow the AI to recognise the physiological sensations of pain and pleasure within itself.

2. The artificial intelligence system of claim 1, wherein the AI may keep original and modified versions of its charts and scales.

3. The artificial intelligence system of claim 1, wherein one or more aspects of the AI may be randomized at one or more points in its existence, including upon or prior to creation, wherein the one or more aspects include but are not limited to: object positioning, accepted frequency range, margin of change, degree of influence, priorities and the change of state mechanics in use in one or more parts of the AI.

4. The artificial intelligence system of claim 1, wherein the positions of objects within charts and scales of the OVS² create personalities by controlling what the AI reacts to and to what degree.

5. The artificial intelligence system of claim 1, wherein the PARS uses principles of mathematics and/or formal logic to determine the priority object of an event when deciding what action or response to make.

6. The artificial intelligence system of claim 1, wherein a mechanic used to alter the state of an AI includes a ‘margin of change’ type feature, controlling whether or not an object is within a set range to be able to affect or alter the AI's state.

7. The artificial intelligence system of claim 1, wherein the system is able to understand and identify in devices and/or natural life one or more of the following key aspects of being, based on one or more fundamental properties of any aspect required for its recognition:
health, by monitoring current performance and efficiency, and then comparing it to an expected performance;
life, by looking for expected functionality a device or natural life needs to use or display in order to be considered alive;
absence, by determining how long an object hasn't been in its presence and comparing that to a given time period; and
death, by determining how long an object hasn't been in its presence and comparing that to a given time period, or by looking for an absence or requirements to be considered alive.

8. The artificial intelligence system of claim 1, wherein the AI comprises memory used for the storage of information about relationships it develops with objects and/or entities prior, during and after events.

9. The relationships of claim 8, wherein one or more mechanics that use principles of mathematics and/or formal logic can set and alter the type, state and/or degree of a relationship between an AI and an entity/object.

10. The relationships of claim 9, wherein the relationship between an AI and entities/objects affect the decisions an AI makes towards the entities/objects.

11. The relationships of claim 9, wherein the relationship between an AI and entities/objects affect the perception of the outcome of a decision/action that affects the entities/objects.

12. The artificial intelligence system of claim 1, wherein the AI comprises memory used for the storage of information about conditions, actions, outcomes and the opinion of the AI in an event to help it learn functions it isn't specifically programmed to do and when it may be best to perform these functions.

13. The learning of new functions of claim 12, wherein the AI does so using one or more of the following features:
Object Value and Sensation System;
Productivity and Reaction System;
Relativism; and
Relationships;
with, primarily, these abilities:
the ability to perform actions;
the ability to record conditions;
the ability to record actions;
the ability to record outcomes;
one or more abilities of observation; and
one or more abilities of communication.

14. The artificial intelligence system of claim 1, wherein one or more mechanics that use principles of mathematics and/or formal logic control how the AI makes decisions, based on one or more of the following, including but not limited to:
the position of objects in charts and scales of the OVS²;
the current state of the AI; and
the relationship between the AI and the object/entity around which the decision is based.

15. The decision making ability of claim 14, wherein priority lists help the AI make decisions based on what it values more.

16. The decision making ability of claim 14, wherein the AI can be forced to make a decision in the event of multiple possible outcomes of equal priority in one or more ways, including but not limited to:
comparing current levels of the object/relationship/other on a scale and picking that with the highest;
comparing current levels of the object/relationship/other on a chart and seeing which makes it feel best (highest level of most desired qualifying emotion);
evaluating changes in levels/positions over time, if these records are kept, and seeing which has the highest average;
evaluating changes in levels/positions over time, if these records are kept, and seeing which has been the most consistent;
evaluating changes in levels/positions over time, if these records are kept, and seeing which improved the most; and
allowing the AI to simply choose which one it wants most.

17. The artificial intelligence system of claim 16, wherein the AI comprises one or more mechanics to decide which method of forced decision making it is to use, including but not limited to:
creating a priority list of methods;
recording the outcomes of the chosen method to allow the AI to determine at a later point in time which is the most effective and/or reliable; and
giving each option a percentage chance of being selected.
